(19) United States
(12) Patent Application Publication
(10) Pub. No.: US 2005/0083693 A1
(43) Pub. Date: Apr. 21, 2005

(54) Flag illumination fixture

(76) Inventor: Timothy Garrett, Ansonia, CT (US)

Correspondence Address: PERMAN & GREEN, 425 POST ROAD, FAIRFIELD, CT, 06824, US

(21) Appl. No.: 10/689,999

(22) Filed: Oct. 21, 2003

(51) Int. Cl. F21V 33/00

(52) U.S. Cl. 362/253; 362/276; 362/431

(57) ABSTRACT

An automatic flag illumination system for illuminating a flag on a flag pole. The system has a fixture enclosure adapted to be mounted on the flag pole. A light is source mounted within the fixture enclosure and a first interchangeable section is supported by the fixture enclosure. A light sensitive device is mounted on the first interchangeable section, the light sensitive device being adapted to activate the light source at dusk. A second interchangeable section has the same features as the first interchangeable section for mounting the light sensitive device and further for being supported by the fixture enclosure.

### BACKGROUND

1. Field of the Exemplary Embodiments

The present invention relates to flag illumination fixtures and, more particularly, to automatic flag illumination systems for illuminating flags on flag poles.

2. Brief Description of Earlier Related Developments

Flag illumination systems make flags such as national flags, state or organizational flags on flagpoles visible during poor weather or at night. Various flag illuminations systems have been devised, such as disclosed in U.S. Pat. No. 6,227,682, which is hereby incorporated by reference in its entirety, that illuminate flags on flag poles. A problem arises when the flag pole user desires to have a feature be provided at the top of the illuminated flag pole, such as a ball, and desires to change the feature, such as, for example, to reflect different holidays or changing seasons. A further problem arises when the flag pole user desires to add illumination to a flag pole that is not illuminated or to move the system from one illuminated flag pole to another different flag pole that is not illuminated. Accordingly, there is a desire to provide a flag pole illumination system that allows the user to easily interchange features, such as a ball, and further allows the user to easily move the system from one illuminated flag pole to another flag pole that is not illuminated. Further, there is a desire to provide such a flag illumination system that is both automatic and sealed from weather.

### SUMMARY OF THE EXEMPLARY EMBODIMENTS

In accordance with one exemplary embodiment, an automatic flag illumination system for illuminating a flag on a flag pole is provided having a fixture enclosure adapted to be mounted on the flag pole. A light source is mounted within the fixture enclosure. A first interchangeable section is supported by the fixture enclosure. A light sensitive device is mounted on the first interchangeable section with the light sensitive device being adapted to activate the light source at dusk. A second interchangeable section having the same features as the first interchangeable section is provided for mounting the light sensitive device and further for being supported by the fixture enclosure.

In accordance with another exemplary embodiment, an automatic flag illumination system for illuminating flags on flag poles is provided having a fixture enclosure adapted to be mounted on a flag pole. A light source is mounted within the fixture enclosure. An interchangeable section is supported by the fixture enclosure. A light sensitive device is electrically coupled to the light source with the light sensitive device being adapted to activate the light source at dusk. The interchangeable section is adapted to be replaced by a different second interchangeable section. The system is adapted to be movable and mountable as a unit from the flag pole that is illuminated to a different flag pole that is not illuminated.

### BRIEF DESCRIPTION OF THE DRAWINGS

The foregoing aspects and other features of the present invention are explained in the following description, taken in connection with the accompanying drawings, wherein:

FIG. 1 is a side view of a flag pole having a fixture incorporating features in accordance with one exemplary embodiment of the present invention;

FIG. 2 is a functional block diagram of the automatic flag illumination system in FIG. 1; and

FIG. 3 is a side schematic section view of the automatic flag illumination system in FIG. 1.

### DETAILED DESCRIPTION

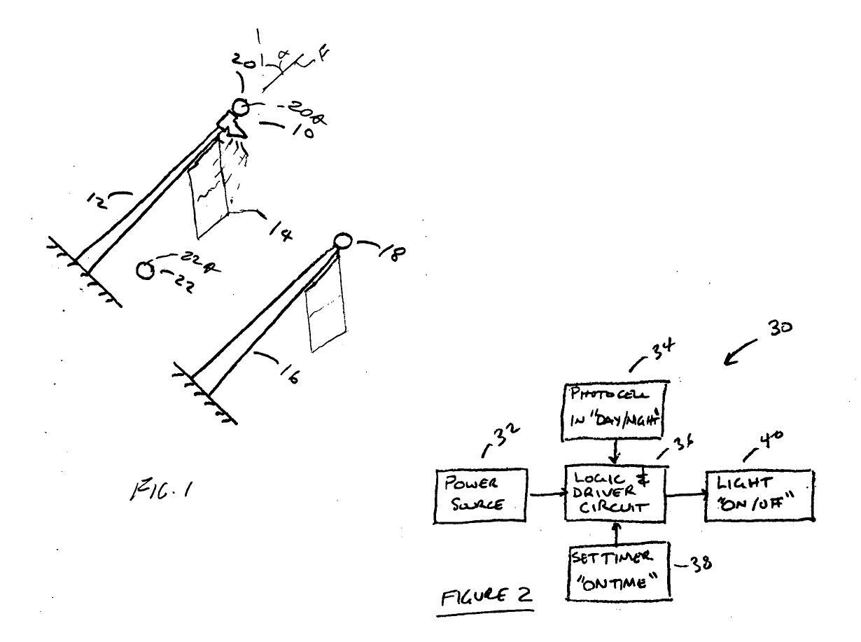

Referring to FIG. 1, there is shown a side schematic section view of a flag pole 12 having a fixture 10 incorporating features of an exemplary embodiment the present invention. Although the present invention will be described with reference to the embodiments shown in the drawings, it should be understood that the present invention can be embodied in many alternate forms of embodiments. In addition, any suitable size, shape or type of elements or materials could be used.

Fixture or automatic flag illumination system 10 is mounted on flagpole 12 and illuminates flag 14. The flag pole 12 is shown in FIG. 1 as being mounted at an incline for example purposes. The incline angle α between a centerline axis F of the flag pole 12 and the vertical is about 45° in the exemplary embodiment of FIG. 1. In alternate embodiments the flag pole may have any desired inclination between vertical and horizontal. The flag pole user may add illumination to flag pole 16 that is not illuminated or move the system 10 from illuminated flag pole 12 to different flag pole 16 that is not illuminated. Fixture or automatic flag illumination system 10 may be mounted on flagpole 16 that does not have a flag illumination fixture or system simply by removing ball 18 and mounting fixture 10 on flagpole 16 in the place of ball 18. Fixture 10 has a feature 20, with a predetermined indicia 20A such as a ball or eagle for example, provided at the top of the illuminating fixture 10. In alternate embodiments, other shapes, colors or patterns could be provided. The user may change feature 20 to alternate feature 22, such as, for example, to reflect different holidays or changing seasons. Feature 22 may have different predetermined indicia 22A such as color, pattern, or shape differences than feature 20 to reflect the users desire to display different features without having to duplicate fixture 10. Fixture 10 is configured to provide illumination to flag 14 supported from the flag pole while minimizing scattered light.

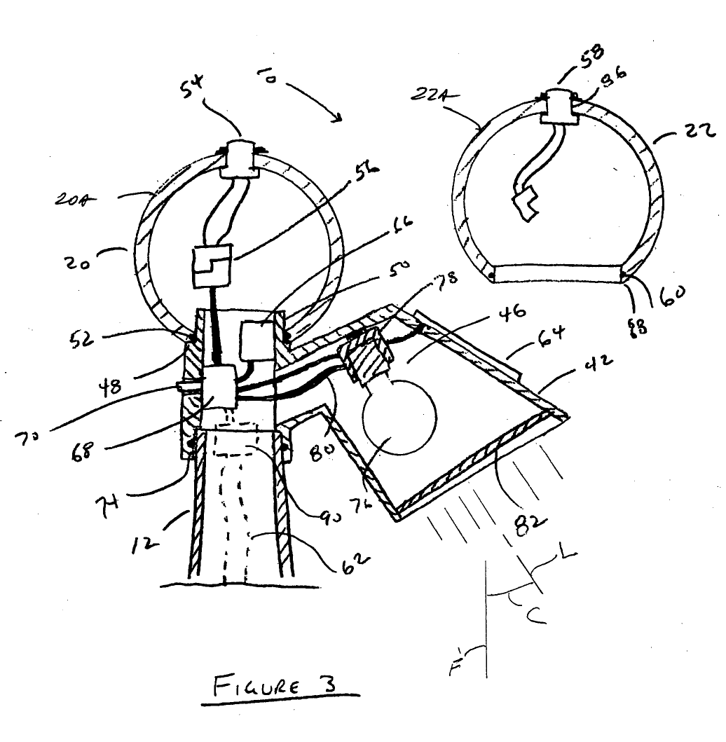

Referring now to FIG. 2, there is shown a functional block diagram 30 of an automatic flag illumination system 10 incorporating features of the present invention. Logic and/or driver circuit 36 accepts inputs from power source 32, photo detector 34 and timer 38. The output of circuit 36 determines the mode 40 of illumination for the light source. Power source 32 may be an AC or DC power source, such as with 100 VAC or DC batteries or an AC supply that is then rectified into a DC source. Alternately, power source 32 may comprise a solar cell, storage battery and regulation and/or charging circuitry. In alternate embodiments, other types of power sources may be provided. Photo detector 34 or light detecting circuit 34 provides an output to logic and driver circuit or as a switch indicating if it is daytime, nighttime. Timer 38 may be provided to allow the user to select a time shorter than a full nighttime for the light to be active/on. The mode 40 of illumination for the light source is determined by the state of photo detector 34 or light detecting circuit 34 and/or timer 38. Generally, if photo detector 34 or light detecting circuit or switch 34 indicates nighttime, the mode 40 of illumination for the light source will be “on”. Generally, if photo detector 34 or light detecting circuit or switch 34 indicates daytime, the mode 40 of illumination for the light source will be “off”. In the event timer 38 is employed, generally, if photo detector 34 or light detecting circuit or switch 34 indicates nighttime and the user settable “on time” has not been achieved since nighttime, the mode 40 of illumination for the light source will be “on”. In alternate embodiments, the timer 38 or photo detector 34 or light detecting circuit or switch 34 may be employed in all various combinations, such as for example where there is no photodetector and an absolute timer is employed with a fixed “on” and “off” time on a twenty four hour cycle.

Referring now to FIG. 3, there is shown a schematic section view of an automatic flag illumination system 10 according to the present invention. The system is adapted to be movable and mountable as a unit from flag pole 12 that is illuminated to a different flag pole that is not illuminated. The system has fixture enclosure 42 adapted to be mounted on flag pole 12 at interface 74 which may have locating features, seals and supporting features such as a flange. Fixture enclosure 42 may be made from plastic, metal or other suitable material. A light source 46 is mounted within fixture enclosure 42. Light source 46 may have a bulb 76, socket 78 and interconnect wires 80. Light source 46 may be mounted at an angle such as for example, 20 degrees or forty five degrees or other suitable angle. A shield 82 which may be clear, colored or otherwise may be provided. As seen in FIG. 3 the fixture enclosure 42 is positioned relative to the interface 74 for the flag pole 12 so that the light from bulb 76 is generally directed parallel with axis L. In the embodiment shown in FIG. 3, axis L forms an angle C of about 200 with axis F¹ (that is parallel to flag pole axis F, see FIG. 1). Accordingly, the light from the fixture enclosure 42 is directed in the region where the flag 14 hangs below the flag pole 12. The light from the fixture falls on the flag and illuminates substantially only the flag. In alternate embodiments the fixture 42 may have any other desired inclination relative to the flag pole to provide lighting generally only for the flag.

The first removable or interchangeable section 20 is supported by fixture enclosure 42. Fixture enclosure 42 has a shoulder 48 and a locating feature 50 supporting and locating first removable or interchangeable section 20. Locating feature 50 may be a diameter. In alternate embodiments, other suitable shapes for the shoulder, locating feature or supporting feature may be used. First removable or interchangeable section 20 may be sealed to fixture enclosure 42 at shoulder 48 or locating feature 50 with seal 52 or simply without seal 52 by allowing water to run off and not into the fixture. A light sensitive device 54 is mounted on first removable or interchangeable section 20. Light sensitive device 54 may be a photo detector, switch, or other suitable device. Light sensitive device 54 may be removably mounted on the first removable or interchangeable section 20. Light sensitive device 54 is electrically coupled to the light source 46 either directly or through logic and or driver circuitry. An electrical disconnect 56 may be provided electrically coupling light sensitive device 54 to light source 46 either directly or through other devices. Electrical disconnect 56 may be repeatedly coupled and de-coupled allowing for interchanging feature 20 with other features depending on the users preference. Light sensitive device 54 is adapted to activate the light source at dusk or at a predetermined light level. The second removable or interchangeable section 22 has similar features 86, 88 as first removable or interchangeable section 20 for mounting light sensitive device 54 or a different light sensitive device 58 and further for being supported by fixture enclosure 42. First removable or interchangeable section 20 is adapted to be replaced by the different second removable or interchangeable section 22. First removable or interchangeable section 20 may be sealed to fixture enclosure 42. Second removable or interchangeable section 22 may similarly be sealed to the fixture enclosure 42 by incorporating features such as seal 60. First removable or interchangeable section 20 may be, at least partially, spherical in shape as shown. The section 20, as noted before, has some desired predetermined indicia 20A which may be its outer shape, surface texture, or color. In alternate embodiments, other suitable shapes or features may be provided. Second removable or interchangeable section 22 may have a different predetermined indicia 22A such as different color, have different shapes or other different features from first interchangeable section 20. The user selects the section 20, 22 to be mounted to fixture enclosure 42. Although only two interchangeable sections are shown in FIGS. 1 and 3 (for example purposes), the system 10 may have any desired number of similar interchangeable sections.

A power source 62 is electrically coupled to the light source 46. The power source 62 may comprise an AC or DC electrical power source and may have a disconnect 90 allowing the user to remove and replace fixture 10. Alternately, the power source may comprise solar cell 64 and battery 66 and may further have a regulator and/or charge controller. A timer and/or controller and/or driver and/or logic circuitry 68 may be electrically coupled to the light source, the power source and the light detector. In alternate embodiments, other suitable wiring arrangements may be employed, such as, for example, wiring the light detector as a switch to the light source or otherwise. In the event a timer is employed, the user may operably set the timer duration with control knob 70. The timer 68 activates and/or de-activates light source 46 after a time period or in a regular time period.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

1. An automatic flag illumination system for illuminating a flag on a flag pole, the system comprising:
a fixture enclosure adapted to be mounted on the flag pole;
a light source mounted within the fixture enclosure;
a first interchangeable section adapted to be removably mounted to the fixture enclosure;
a light sensitive device mounted on the first interchangeable section, the light sensitive device being adapted to activate the light source in response to sensing a predetermined level of light; and
a second interchangeable section adapted to be removably mounted to the fixture enclosure, the second interchangeable section being interchangeable with the first interchangeable section and having a different predetermined characteristic from the first interchangeable section.

2. The automatic flag illumination system of claim 1 wherein the first interchangeable section is sealed to the fixture enclosure and wherein the second interchangeable section may be sealed to the fixture enclosure.

3. The automatic flag illumination system of claim 1 further comprising a power source electrically coupled to the light source.

4. The automatic flag illumination system of claim 3 wherein the power source comprises a solar cell and a battery.

5. The automatic flag illumination system of claim 1 wherein the first interchangeable section is, at least partially, spherical in shape and wherein the different predetermined characteristic is a different surface indicia from the first interchangeable section.

6. The automatic flag illumination system of claim 1 wherein the fixture enclosure has a shoulder and a locating feature supporting the first interchangeable section.

7. The automatic flag illumination system of claim 6 wherein the first interchangeable section is sealed to the fixture enclosure at the shoulder or the locating feature.

8. An automatic flag illumination system for illuminating flags on flag poles, the system comprising:
a fixture enclosure adapted to be mounted on a flag pole;
a light source mounted within the fixture enclosure;
an interchangeable section supported by the fixture enclosure; and
a light sensitive device electrically coupled to the light source, the light sensitive device being adapted to activate the light source at dusk;
wherein, the interchangeable section is interchangeable from a number of different interchangeable sections, each of the different interchangeable sections having a different predetermined characteristic, and wherein the system is adapted to be movable and mountable as a unit from the flag pole a different flag pole.

9. The automatic flag illumination system of claim 8 wherein the interchangeable section is sealed to the fixture enclosure and wherein the light sensitive device is mounted to the interchangeable section.

10. The automatic flag illumination system of claim 8 further comprising a power source electrically coupled to the light source, wherein the power source comprises a solar cell and a battery.

11. The automatic flag illumination system of claim 11 further comprising a timer electrically coupled to the light source, wherein the timer de-activates the light source after a time period.

12. The automatic flag illumination system of claim 8 wherein the interchangeable section is, at least partially, spherical in shape and wherein the different predetermined characteristic is a different indicia.

13. The automatic flag illumination system of claim 11 further comprising an electrical disconnect electrically coupling the light sensitive device to the light source, the electrical disconnect being adapted to be repeatedly coupled and decoupled, wherein the fixture enclosure has a shoulder and a locating feature supporting the interchangeable section, wherein the interchangeable section is sealed to the fixture enclosure at the shoulder or the locating feature, and wherein the light sensitive device is mounted to the interchangeable section.

14. The automatic flag illumination system of claim 8, wherein the fixture enclosure directs light from the light source at an incline relative to the flag pole.

15. A method for illuminating a flag on a flag pole, the method comprising:
providing an enclosure adapted to be mounted on the flag pole;
providing a light source mounted within the enclosure;
providing a first removable section capable of being removably mounted to the enclosure;
providing a light sensitive device removably mounted on the first removable section, the light sensitive device being adapted to activate the light source at dusk;
providing an electrical disconnect electrically coupling the light sensitive device to the light source, the electrical disconnect being adapted to be repeatedly coupled and decoupled;
providing a second removable section capable of being removably mounted to the enclosure and being adapted for mounting the light sensitive device thereon; and
selectably mounting the first removable section or second removable section on the enclosure.
